(19) United States
(12) Patent Application Publication
(10) Pub. No.: US 2013/0033747 A1
(43) Pub. Date: Feb. 7, 2013

(54) THREE DIMENSIONAL DISPLAY PANEL AND PHASE RETARDATION FILM THEREOF

(71) Applicants: Shin-Yi HUANG, Taoyuan County (TW); Cyun-Tai HONG, New Taipei City (TW)

(72) Inventors: Shin-Yi HUANG, Taoyuan County (TW); Cyun-Tai HONG, New Taipei City (TW)

(73) Assignee: BENQ MATERIALS CORPORATION, Taoyuan County (TW)

(21) Appl. No.: 13/450,494

(22) Filed: Apr. 19, 2012

(30) Foreign Application Priority Data
Aug. 4, 2011 (TW) 100127763

(51) Int. Cl. G02B 27/22; G02B 5/30

(52) U.S. Cl. 359/462; 359/489.07

(57) ABSTRACT

A three dimensional display panel and a phase retardation film thereof are provided. The three dimensional display panel includes pixel units and a phase retardation film. Each pixel unit includes sub-pixel units corresponding to different color display areas. The phase retardation film includes a plurality of first phase regions and a plurality of second phase adjusting regions. The first phase regions and the second phase regions alternately arranged both in horizontal and vertical directions as a chessboard-like pattern for corresponding to the sub-pixel units, wherein a difference between a phase retardation of the first phase regions and a phase retardation of second phase regions is ½ wavelength (λ).

### RELATED APPLICATIONS

This application claims the priority benefit of Taiwan application serial no. 100127763, filed on Aug. 4, 2011, the full disclosure of which is incorporated herein by reference.

### BACKGROUND OF THE INVENTION

1. Field of the Invention

The invention generally relates to a display panel, and more particularly to a three dimensional (3D) display panel and a phase retardation film thereof.

2. Description of the Related Art

In general, a 3D image displayed on a display device such as a TV or a monitor is constructed by two images with different viewing angles in response to the left eye and the right eye respectively base on a so-called binocular parallax which is the difference between images viewed by two eyes. The left-eye image and the right-eye image are respectively transmitted to the left eye and the right eye through a specific phase retardation film of the 3D display panel and a pair of polarized 3D glasses, thereby forming a 3D image in a user's brain.

FIG. 1 is a schematic view illustrating a conventional 3D display panel 100. For displaying a 3D image, a phase retardation film 110 with two types of phase retardation regions A and B is attached to a 3D display panel 100. According to the two types of phase retardation regions A and B of the phase retardation film 110, the odd lines of pixels of the panel, such as L1, L3 and L5, are corresponding to the phase retardation regions A, and the even lines of pixels of the panel, such as L2 and L4, are corresponding to the phase retardation regions B. Thus, the light transmitted from the odd lines of pixels through the phase retardation regions A to display a left-eye image, and the light transmitted from the even lines of pixels through the phase retardation regions B to display a right-eye image, are in different polarization states, such that a viewer may obtain a 3D image by wearing polarized 3D glasses.

Referring to FIG. 2, it shows an original image from a 2D display and an image of a single eye received from the conventional 3D display panel 100. In the conventional 3D display panel, the image for the left eye and the image for the right eye are simultaneously displayed. For example, one single eye of a user sees the image displayed only by the odd lines of pixels on the panel illustrated in FIG. 2, so that the resolution of the image in a vertical direction viewed by the user is reduced to half of the original resolution. Hence, the image displayed from the conventional 3D display panel 100 is discontinuous and the quality is not good enough for viewing.

For maintaining the resolution of 3D display panel, a method of reducing the size of pixel unit of the panel has been widely used. However, the method of reducing the size of pixel unit is very expensive and only less light can pass through a smaller pixel unit which would reduce the brightness of 3D display panel.

### SUMMARY OF THE INVENTION

In order to improve the discontinuousness of the 3D image viewed by user, a 3D display panel and a phase retardation film thereof are provided in the present invention. In the conventional 3D display panel, two types of phase retardation regions are arranged in line directions alternately. Comparatively speaking, the phase regions of the phase retardation film in the present invention are arranged alternately both in horizontal and vertical directions as a chessboard-like pattern, so as to eliminate the discontinuousness of the image viewed by a user.

According to an aspect of the present invention, a 3D display comprises a plurality of pixel units, wherein each of the pixel units further includes a plurality of sub-pixel units corresponding to different color display areas; and a phase retardation film disposed on the pixel units, wherein the phase retardation film has a plurality of first phase regions and a plurality of second phase regions alternately arranged both in horizontal and vertical directions as a chessboard-like pattern for corresponding to the sub-pixel units. A difference between a phase retardation of the first phase regions and a phase retardation of second phase regions is ½ wavelength (λ). In accordance with one embodiment of the present invention, the first phase regions on which a first aligned pattern is disposed have the phase retardation of ¼λ and the second phase regions on which a second aligned pattern is disposed have the phase retardation of −¼λ. The color display areas include a red area, a yellow area and a green area.

According to another embodiment of the invention, the first phase regions on which a first aligned pattern is disposed have the phase retardation of ½λ and the phase retardation of the second phase regions is substantially zero.

According to yet another aspect of the invention, a retardation film applicable to 3D display panel, comprises a plurality of first phase regions; and a plurality of second phase regions, wherein the first phase regions and the second phase regions are alternately arranged both in horizontal and vertical directions as a chessboard-like pattern for corresponding to the sub-pixel units. A difference between a phase retardation of the first phase regions and a phase retardation of second phase regions is ½λ. The first phase regions on which a first aligned pattern is disposed have the phase retardation of ¼λ, and the second phase regions on which a second aligned pattern is disposed have the phase retardation of −¼λ.

According to yet another aspect of the invention, the first phase regions on which a first aligned pattern is disposed have the phase retardation of ½λ, and the phase retardation of the second phase regions is substantially zero.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic view illustrating a conventional 3D display panel and a phase retardation film thereof.

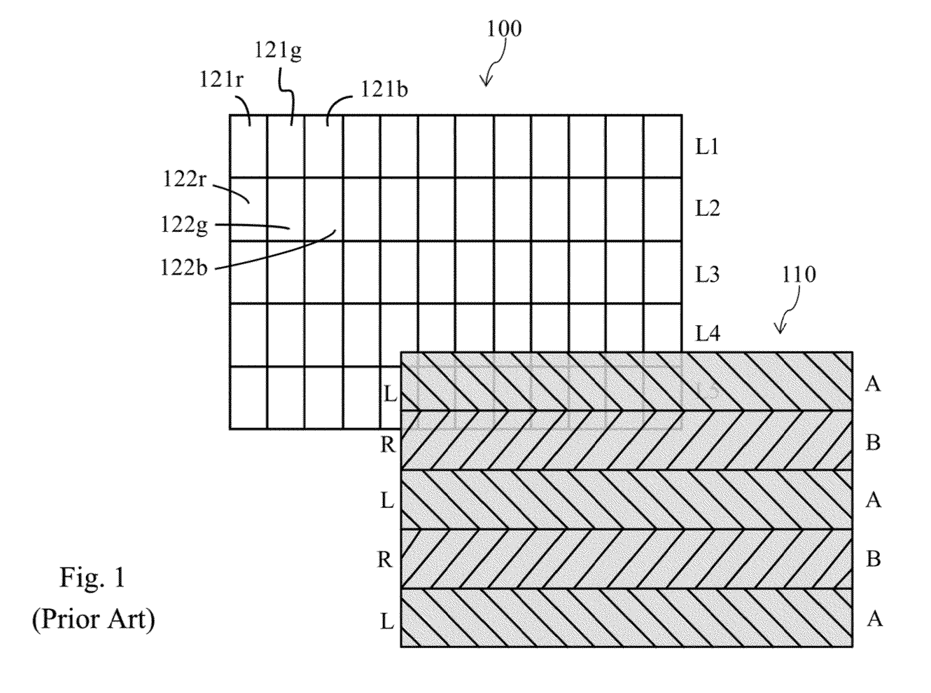

FIG. 2 shows an original image of 2D display panel and an image of a single eye received from the conventional 3D display panel.

FIG. 3 shows pixel units of a 3D display panel of an embodiment of the present invention.

FIG. 4 shows pixel units of a 3D display panel and a phase retardation film thereof.

FIG. 5 is a schematic view illustrating a left eye image and a right eye image corresponding to the phase retardation film in FIG. 4.

FIG. 6 is a simulation of an image of the 3D display of the present invention.

### DETAILED DESCRIPTION OF THE INVENTION

Please note that the drawings shown in the Figures are for illustrative purposes only and not to scale

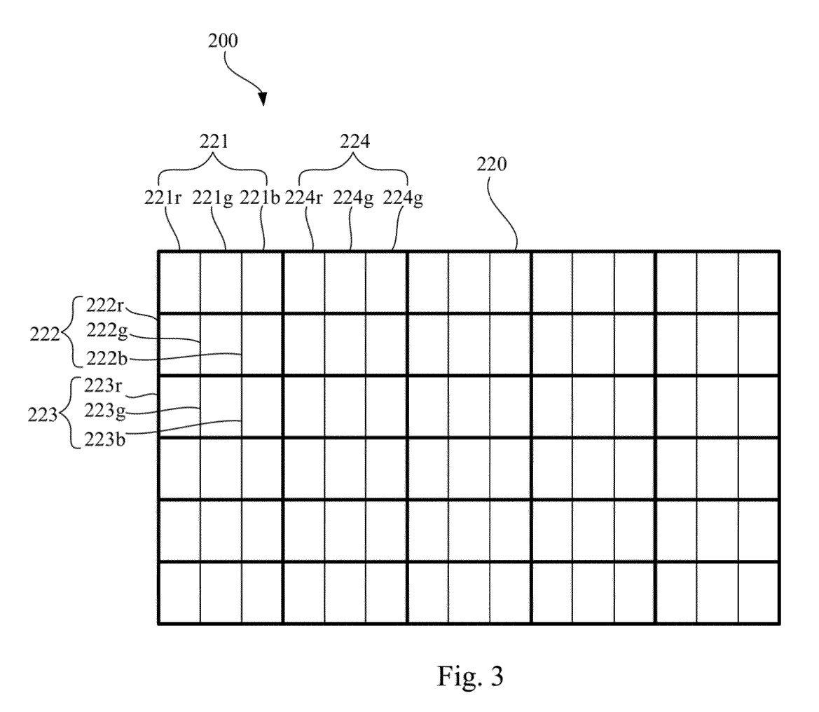

Referring to FIG. 3, FIG. 3 shows pixel units of a 3D display panel 200 of an embodiment of the present invention. The 3D display panel 200 has a plurality of pixel units 221, 222, 223 and 224, wherein each pixel unit further includes a plurality of sub-pixel units corresponding to different display color areas. For example, the pixel unit 221 includes sub-pixel units 221r, 221g and 221b, wherein the sub-pixel unit 221r is corresponding to the display color areas of red color, and the sub-pixel unit 221g is corresponding to the display color areas of green color, and the sub-pixel unit 221b is corresponding to the display color areas of blue color.

It is noted that the type of the 3D display panel is not limited to a certain type of panel in the present invention. For example, the display panel can be a twisted nematic (TN) LCD panel, a multi-domain vertical alignment (MVA) LCD panel or an in-plane switching (IPS) LCD panel. Furthermore, the display color areas of the 3D display panel are not limited to including the red area, yellow area and blue area.

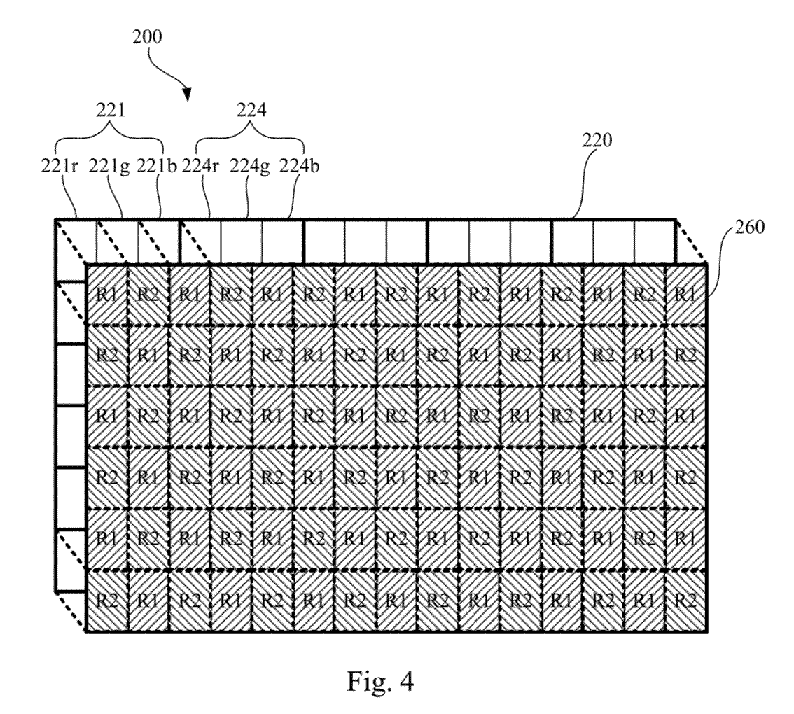

Referring to FIG. 4, FIG. 4 is a schematic view illustrating the pixel units of a 3D display panel 200 and a phase retardation film 260 of the 3D display panel 200. The phase retardation film 260 is deposited on the 3D display panel 200, and includes a plurality of first phase regions R1 and a plurality of second phase regions R2, wherein the first phase regions R1 and the second phase regions R2 are alternately arranged both in horizontal and vertical directions as a chessboard-like pattern for corresponding to the positions of sub-pixel units. For example, the first phase regions R1 are corresponding to sub-pixel units 221r, 221b and 224g, and the second phase regions are corresponding to sub-pixel units 221g, 224r and 224b. Furthermore, the size of each first phase region and that of each second phase region are the same as the sub-pixel unit of the 3D display panel 200. In addition, the difference between the phase retardation of the first phase regions R1 and the phase retardation of second phase regions R2 is ½λ. For example, the first phase regions R1 include a first aligned pattern directed to a first direction to make the first phase regions have the phase retardation of ¼λ, and the second phase regions R2 include a second aligned pattern directed to a second direction to make the second phase regions have the phase retardation of −¼λ. Therefore, the difference between the phase retardation of the first phase regions R1 and the phase retardation of second phase regions R2 is ½λ.

The phase retardation of the first phase regions and the second phase regions are not limited to the above. In another embodiment of the invention, the phase retardation of the first phase regions and the second phase regions can be ½λ and 0 respectively.

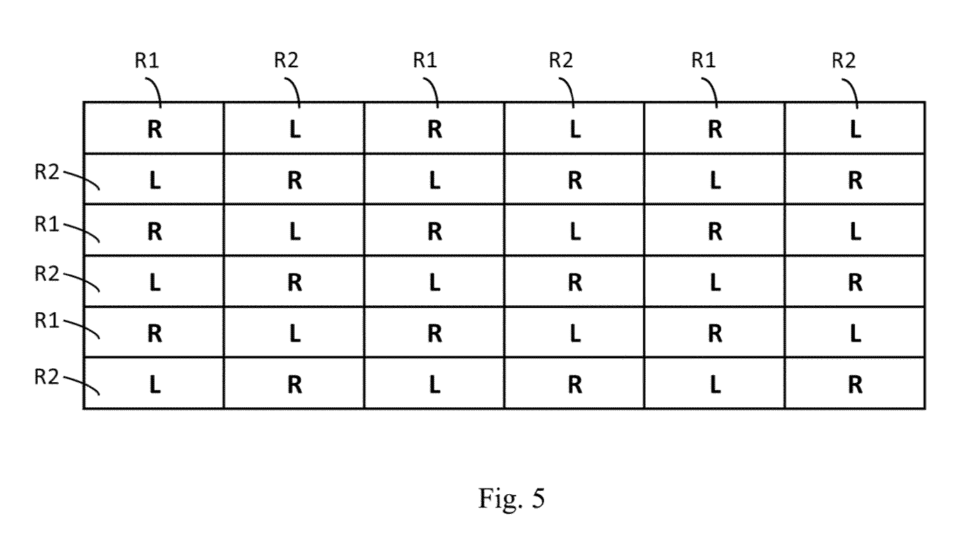

Referring to FIG. 4 and FIG. 5, when the image is displayed by the 3D display panel 200 in FIG. 4, the light passing through the first phase regions R1 and the light passing through the second regions R2 of the phase retardation film 260 are in different polarization states. As a result, the two different polarization states are respectively corresponding to the two eyes of a viewer. For example, the first phase regions R1 are corresponding to the right eye and the second phase regions R2 are corresponding to the left eye, as shown in FIG. 5.

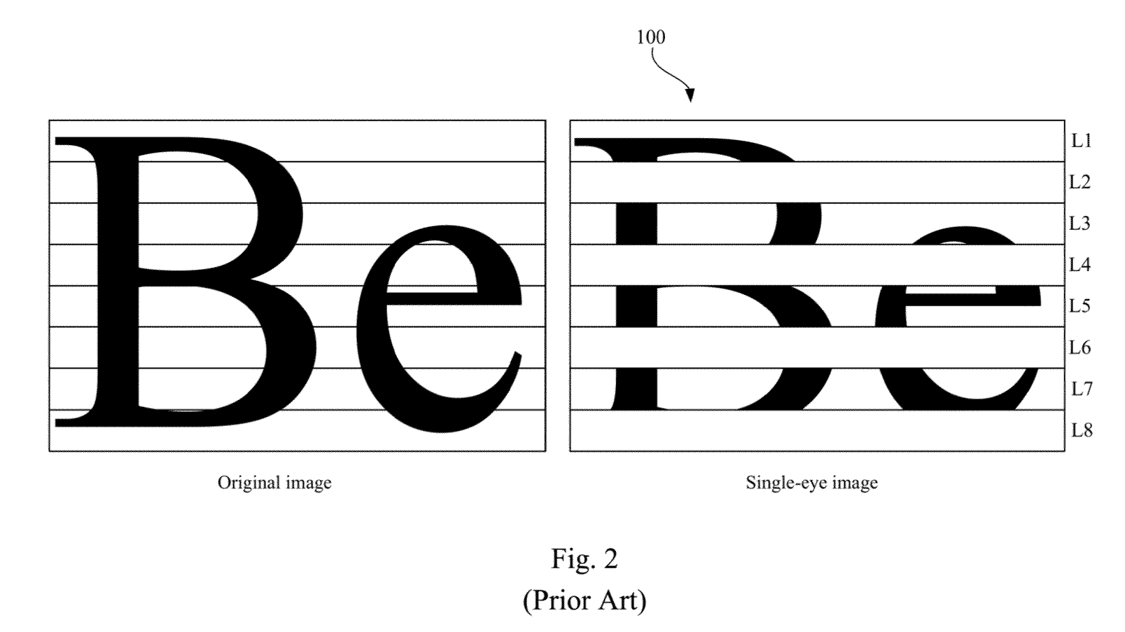

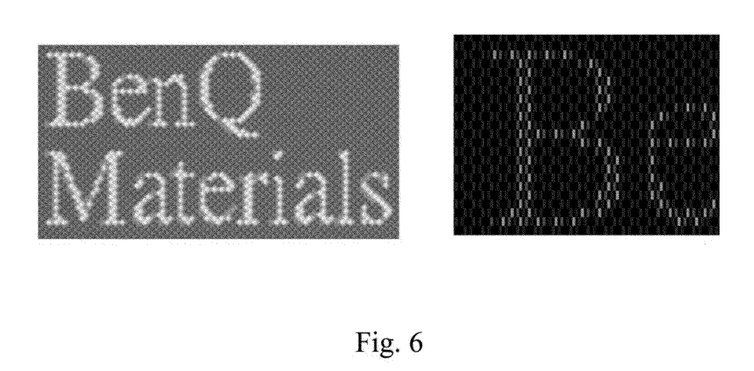

Referring to FIG. 6, FIG. 6 shows a simulation of an image in 3D display of the invention. The image in FIG. 6, as the 3D image taken by one single eye of a viewer, has been improved on the discontinuousness in comparison with the conventional image provided in FIG. 2.

As a result, a 3D display panel and a phase retardation film of the 3D display panel are provided in the present invention. The phase regions of the phase retardation film in the present invention are arranged alternately both in horizontal and vertical directions as a chessboard-like pattern, so as to improve the discontinuousness of the image.

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A three dimensional display, comprising:
a plurality of pixel units, wherein each of the pixel units further includes a plurality of sub-pixel units corresponding to different color display areas; and
a phase retardation film disposed on the pixel units, wherein the phase retardation film has a plurality of first phase regions and a plurality of second phase regions alternately arranged both in horizontal and vertical directions as a chessboard-like pattern for corresponding to sub-pixel units;
wherein a difference between a phase retardation of the first phase regions and a phase retardation of second phase regions is ½ wavelength (λ).

2. The three dimensional display according to claim 1, wherein the first phase regions on which a first aligned pattern is disposed has the phase retardation of ¼λ, and the second phase regions on which a second aligned pattern is disposed has the phase retardation of −¼λ.

3. The three dimensional display according to claim 1, wherein the first phase regions on which a first aligned pattern is disposed has the phase retardation of ½λ, and the phase retardation of the second phase regions is substantially zero.

4. The three dimensional display according to claim 1, wherein the color display areas include a red area, a yellow area and a green area.

5. A phase retardation film applicable to a three dimensional display device, the phase retardation film comprising:
a plurality of first phase regions; and
a plurality of second phase regions,
wherein the first phase regions and the second phase regions are alternately arranged both in horizontal and vertical directions as a chessboard-like pattern for corresponding to the sub-pixel units;
wherein a difference between a phase retardation of the first phase regions and a phase retardation of second phase regions is ½λ.

6. The phase retardation film according to claim 5, wherein the first phase regions on which a first aligned pattern is disposed has the phase retardation of ¼λ and the second phase regions on which a second aligned pattern is disposed has the phase retardation of −¼λ.

7. The phase retardation film according to claim 5, wherein the first phase regions on which a first aligned pattern is disposed has the phase retardation of ½λ and the phase retardation of the second phase regions is substantially zero.
